(19) United States
(12) Patent Application Publication
(10) Pub. No.: US 2024/0379973 A1
(43) Pub. Date: Nov. 14, 2024

(54) ELECTROCHEMICAL SYSTEM

(71) Applicant: Schaeffler Technologies AG & Co. KG, Herzogenaurach (DE)

(72) Inventors: Van Hau Nguyen, Herzogenaurach (DE); Andreas Nendel, Hessdorf (DE)

(73) Assignee: Schaeffler Technologies AG & Co. KG, Herzogenaurach (DE)

(21) Appl. No.: 18/554,580

(22) PCT Filed: Mar. 9, 2022
(86) PCT No.: PCT/DE2022/100191

§ 371 Date: Oct. 9, 2023

(30) Foreign Application Priority Data
Apr. 9, 2021 (DE) 102021108876.3

(51) Int. Cl. H01M 8/0254; H01M 8/0263; H01M 8/04007; H01M 8/10; H01M 8/1004; H01M 8/241

(52) U.S. Cl. CPC H01M 8/0254; H01M 8/0263; H01M 8/04007; H01M 8/1004; H01M 8/241; H01M 2008/1095

(57) ABSTRACT

An electrochemical system comprises a plurality of stacked bipolar plates, each of which is composed of two structured half-plates that describe corrugation peaks and corrugation valleys. Coolant channels are formed between the half-plates of each bipolar plate by means of the corrugation peaks and corrugation valleys, and at the same time the outer faces of the bipolar plates delimit flow channels for operating media. A membrane assembly is located between each pair of bipolar plates. An assembly of flow channels, said assembly being mirror-symmetrical with respect to a plane on which the membrane assembly lies, transitions into an assembly which is offset in the transverse direction in a transition region between an active field and a distributing field of each bipolar plate.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/2022/100191, filed on Mar. 9, 2022, designating the United States of America, which in turn claims the benefit of priority under 35 U.S.C. §§ 119, 365 of German Patent Application No. 102021108876.3, filed Apr. 9, 2021, the contents of which are relied upon and incorporated herein by reference in their entirety.

### FIELD OF THE DISCLOSURE

The disclosure relates to an electrochemical system, in particular a fuel cell system, which is constructed in stack form.

### BACKGROUND OF THE DISCLOSURE

An electrochemical system is known for example from DE 20 2016 107 302 U1. The known electrochemical system comprises a plurality of bipolar plates, each of which is composed of two separator plates. The separator plates each comprise a through-opening for the passage of a medium and a distribution or collection region having a plurality of webs and channels formed between the webs, which are each in fluid communication with the through-opening. Furthermore, the known separator plate has a flow field which is connected to the through-opening via the distribution or collection region and has conducting structures for conducting a medium.

Another separator plate, which is also provided for use in an electrochemical system, is disclosed in DE 20 2015 104 300 U1. In this case, the term separator plate is used for a complete bipolar plate, wherein this is composed of what are termed individual plates, i.e., half-plates. Contours of channels are formed by the two individual plates, wherein crossing regions exist between different channels.

U.S. Pat. No. 4,983,472 A discloses a plate of a fuel cell which carries an electric current and is arranged between a flat electrode and a further plate. The current-carrying plate has a structuring in the manner of a checkerboard pattern.

### SUMMARY OF THE DISCLOSURE

According to an aspect of the present disclosure, an electrochemical system comprises a plurality of stacked bipolar plates, which are each composed of two structured half-plates describing corrugation peaks and corrugation valleys. Coolant channels are formed between the half-plates of each bipolar plate through the corrugation peaks and corrugation valleys, wherein the bipolar plates at the same time delimit flow channels for operating media on the outer sides thereof, and there is a membrane assembly between each two bipolar plates.

In an active field of the bipolar plate, the flow channels for the media that flow through the stack of bipolar plates are arranged to be mirror-symmetrical to one another, wherein the mirror symmetry relates to the plane in which the membrane assembly lies. Between the distributing field and the active field of each bipolar plate there is a transition region in which the flow channels, which are initially congruent, diverge in such a way that an assembly of flow channels that is offset in the transverse direction of the flow channels, which is on the first side of the membrane assembly, and flow channels which are on the opposite side of the membrane assembly results.

The offset between the flow channels, which are located on opposite sides of each bipolar plate and which increases from the active field to the distributing field within the transition region when viewed from above on the bipolar plate, gives the possibility that the half-plates of the bipolar plate are support components in correspondingly offset surface sections on surrounding, flat surfaces. This means that geometric inaccuracies that can occur during series production can be better compensated for in comparison to conventional solutions while maintaining the required tightness. At the same time, even when the plates are stacked densely, large, streamlined cross-sections of the flow channels delimited by the half-plates can be provided.

According to a first design option for the bipolar plates, the corrugation peaks and corrugation valleys of the first half-plate of each bipolar plate, which form the coolant channels, diverge within the transition region in relation to the corrugation peaks and corrugation valleys of the second half-plate in such a way that separate, mutually parallel coolant channels in each bipolar plate in the active field merge into one coherent one that extends over several corrugation peaks and corrugation valleys for a particularly uniformly cooling coolant chamber. This means that a wide, corrugated, open cross-section formed between the half-plates of a bipolar plate, through which coolant can flow and which is open towards the distributing field of the bipolar plate, splits into individual coolant channels in the direction of the active field when viewed from the distributing field.

In that section of the transition region in which the individual coolant channels of each bipolar plate are combined to form a coolant chamber, the membrane assembly can lie loosely between the adjacent bipolar plates, wherein the deflectability of the membrane assembly through the said bipolar plates, viewed in the transverse direction of the flow channels, is alternately blocked in only one direction, in each case normal to said plane defined by the membrane assembly. The membrane assembly is thus supported alternately, for example, on a bipolar plate which is located on the upper side of the membrane assembly, and on a bipolar plate located on the underside of the membrane assembly, wherein the expressions “top” and “bottom” imply no information about the actual orientation in space of the bipolar plates. In this case, a certain flexibility of the membrane assembly is exploited, which allows a wave-like deflection of the membrane assembly from the plane predetermined by the membrane assembly in the region of the active field.

In particular, the membrane assembly, which lies loosely between the adjacent bipolar plates, can reproduce the corrugated shape of the half-plates in cross-section, but with less pronounced corrugation peaks and corrugation valleys, which gives the impression of a woven structure. In this way, in the corresponding section of the transition region bordering on the distributing field, both the half-plate assemblies and the plate assemblies can absorb deformations in the normal direction of the plate assembly, wherein such deformations can be caused thermally and/or by external forces.

As far as the exact course of the flow channels within the transition region between the distributing field and the active field is concerned, there are different geometric variants:

According to a first variant, the flow channels on the edge of the transition region bordering on the active field are inclined relative to the orientation which the flow channels have on the edge of the transition region bordering on the distributing field. In the typical, vertical orientation of the bipolar plates, the edges mentioned are, for example, the lower and the upper edge of the transition region.

Variants can also be implemented in which the flow channels are aligned in the same direction on both edges of the transition region. In this case, the flow channels on one side of the bipolar plate within the transition region are, for example, completely straight, while the flow channels on the opposite side of the bipolar plate on the edge of the transition region bordering on the active field are offset parallel to that edge of the transition region which borders on the distributing field, wherein the parallel offset can correspond in particular to the width of a flow channel.

If none of the flow channels within the transition region has a completely straight shape, the flow channels within the transition region can, for example, diverge in a Y-shape. The same flow conditions can thus be produced on both sides of the bipolar plate.

The electrochemical system can be provided in the form of a fuel cell stack or fuel cell stacks for mobile or for stationary applications. In particular, the membrane assembly is a polymer electrolyte membrane (PEM), so that a polymer electrolyte fuel cell is present, which is used in particular for operation with hydrogen as the fuel gas.

The bipolar plates are made in particular from three-dimensionally embossed metal sheets, in particular from steel, titanium, or a titanium alloy, and can be provided with coatings and/or be connected to other components, in particular gas diffusion layers of the electrochemical system, which are usually arranged between a membrane assembly and a bipolar plate. In this case, two embossed metal sheets are connected to one another, for example by welding, wherein a coolant chamber through which coolant can flow is formed between the metal sheets.

### BRIEF DESCRIPTION OF THE DRAWINGS

Below, three exemplary embodiments of the present disclosure are explained in more detail by means of a drawing. In the figures:

FIG. 1 shows a section of an electrochemical system in a schematic view,

FIG. 2 is a cross-sectional view of the section of the electrochemical system of FIG. 1, taken at line A-A,

FIG. 3 is a cross-sectional view of the section of the electrochemical system of FIG. 1, taken at line B-B,

FIG. 4 shows an alternative design of an electrochemical system in a view analogous to FIG. 1,

FIG. 5 shows another electrochemical system in a representation analogous to FIG. 1.

### DETAILED DESCRIPTION

Unless otherwise stated, the following explanations relate to all exemplary embodiments. Parts or contours that correspond to each other or have basically the same effect are marked with the same reference symbols in all figures.

An electrochemical system identified overall by the reference number 1 is a fuel cell stack.

The electrochemical system comprises a large number of bipolar plates 2, which are each formed from two half-plates 3, 4 and are stacked to form a stack. Membrane assemblies located between the bipolar plates 2 are denoted by 5. Compared to the bipolar plates 2, the membrane assemblies 5 have increased flexibility, at least in certain surface sections. This flexibility relates in particular to the resilience in the event of loads which act in a perpendicular manner on the essentially plate-shaped, stacked assemblies 2, 5. Said flexibility can be expressed, among other things, in a waveform 22 described by the membrane assembly 5, which will be discussed in more detail below.

Media conducted through the electrochemical system 1 flow through a distributing field 8, a transition region 7, and an active field 6 in which the desired electrochemical reactions take place. In contrast, no electrochemical reactions take place in the distributing field 8 and in the transition region 7. The membrane assembly 5 therefore has a structure within the distributing field 8 and the transition region 7 which differs from the structure within the active field 6.

Numerous flow channels 9, which are located on the first side of the membrane assembly 5, are separated from flow channels 10 on the second side of the membrane assembly 5 by the membrane assembly 5 from the distributing field 8 to the active field 6. The first side of the membrane assembly 5 is referred to in the present case, without limiting generality, as the top, and the second side of the membrane assembly 5 is also referred to as the underside.

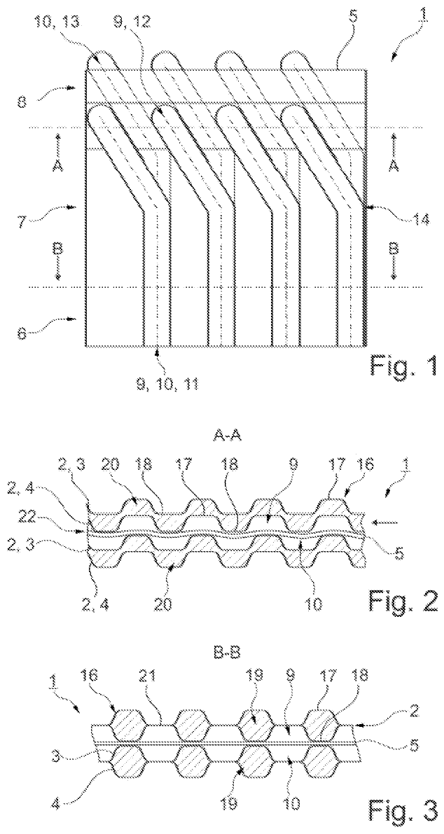

The output sections of the flow channels 9, 10 located within the active field 6 are denoted uniformly by 11. All output sections 11 are arranged to be parallel to one another, wherein one output section 11 is always arranged on the upper side of the membrane assembly 5 in a mirror-symmetrical manner with respect to an output section 11 on the underside of the membrane assembly 5. In relation to the view according to FIGS. 1, 4, and 5, this means that two output sections 11 are arranged exactly one above the other within the active field 6. In contrast thereto, the input sections of the flow channels 9, 10, which are designated 12, 13, are alternately next to one another, as can also be seen from FIGS. 1, 4, and 5.

This means that an input section 12, which is attributable to a flow channel 9, is in any case next to an input section 13, which is attributable to a flow channel 10, or is adjacent to two input sections 13. In the top view, this represents a fanning out of the flow channels 9, 10 within the transition region 7, which fluidically connects the active field 6 with the distributing field 8.

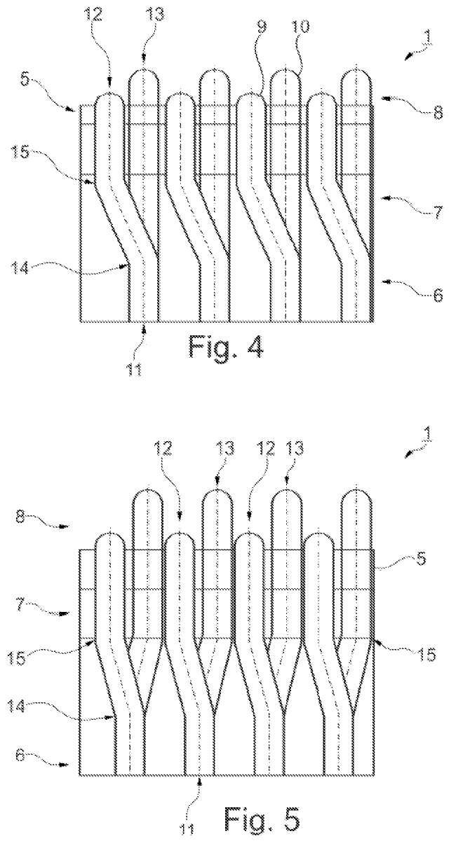

In all of the exemplary embodiments, the flow channels 9 at the top in the figures have a first bend point 14 within the transition region 7. In the cases shown in FIGS. 4 and 5, a second bend point 15 of a flow channel 9 is also provided. Deviating from the simplified illustrations, what are termed the bend points 14, 15 can be rounded.

In the case of FIG. 1, the flow channel 10 lying at the bottom in the outlined exemplary embodiments has a single bend point 14; in the case of FIG. 4 it is a continuously straight course; and in the case of FIG. 5 there are two bend points 14, 15. In all cases, all of the input sections 12, 13 of the flow channels 9, 10 are aligned to be parallel to one another. In the case of FIG. 1, the input sections 12, 13 are inclined relative to the output sections 11, whereas all sections 11, 12, 13 are parallel in the configurations according to FIGS. 4 and 5.

Each half-plate 3, 4 has a corrugated structure 16, through which corrugation peaks 17 and corrugation valleys 18 are described. A corrugation peak 17 is arranged to be mirror-symmetrical to a corrugation valley 18 in the active field 6, so that a coolant channel 19 is formed therebetween. Coolant channels 19 running parallel to one another are separated from one another by webs 21, which are formed by sections of the half-plates 3, 4 lying one on top of the other. In the region of the webs 21, the half-plates 3, 4 can be welded or soldered to one another. The flow channels 9, 10 are each located between the membrane assembly 5 and a web 21, wherein at the same time they border on two respective coolant channels 19.

Within the transition region 7, the corrugated structures 16 of the half-plates 3, 4 are shifted relative to one another in such a way that, as is shown by FIG. 2, which also applies to the variants according to FIGS. 4 and 5, a corrugation peak 17 is always located above a corrugation peak 17, and a corrugation valley 18 is always located above a corrugation valley 18. The coolant channels 19 are thus separated and combined to form a single coolant chamber 20, which meanders between the half-plates 3, 4 in the section (FIG. 2). In contrast to the coolant channels 19, the flow channels 9, 10 can still be distinguished from one another, wherein the separation is provided by the membrane assembly 5. As a comparison of FIGS. 3 and 2 illustrates, however, the half-plates 3, 4, which form continuous coolant chambers 20, do not rigidly fix the membrane assembly 5. Rather, the membrane assembly 5 can lie in a serpentine waveform 22 between half-plates 4, 3 of adjacent bipolar plates 2. Associated with elastic deflections of the half-plates 3, 4, changes in the shape of the membrane assembly 5 are also possible to a limited extent in that section of the transition region 7 which borders on the active field 6.

### LIST OF REFERENCE NUMERALS

1 Electrochemical system
2 Bipolar plate
3 Half-plate
4 Half-plate
5 Membrane assembly
6 Active field
7 Transition region
8 Distributing field
9 Flow channel on the first side of the membrane assembly
10 Flow channel on the second side of the membrane assembly
11 Output section of a flow channel
12 Input section of a flow channel
13 Input section of a flow channel
14 First bend point in a flow channel
15 Second bend point in a flow channel
16 Corrugated structure of a half-plate
17 Corrugation peak
18 Corrugation valley
19 Coolant channel
20 Coolant chamber
21 Web
22 Membrane assembly waveform

1. An electrochemical system, comprising:
a plurality of stacked bipolar plates, each having first and second half-plates that include corrugation peaks and corrugation valleys that cooperate to form coolant channels between the first and second half-plates, the bipolar plates having outer sides that delimit flow channels for operating media; and
a plurality of membrane assemblies, each being located between each pair of adjacent bipolar plates, respectively, wherein in a transition region between an active field and a distributing field of each bipolar plate, the flow channels delimited by the outer sides of adjacent bipolar plates change from a mirror-symmetrical arrangement with respect to a plane in which the membrane assembly is located to an arrangement offset in a direction transverse to the flow channels.

2. The electrochemical system of claim 1, wherein within the transition region, the corrugation peaks and corrugation valleys of the first half-plate of each bipolar plate forming the coolant channels are positioned to diverge with respect to the corrugation peaks and corrugation valleys of the second half-plate in such a way that coolant channels in each bipolar plate that are separate from and parallel to each other in the active field merge into a coherent coolant chamber extending over several corrugation peaks and corrugation valleys.

3. The electrochemical system of claim 2, wherein in the section of the transition region in which the individual coolant channels of each bipolar plate are combined to form the coherent coolant chamber, one of the plurality of membrane assemblies lies loosely between adjacent bipolar plates, wherein the deflectability of the membrane assembly is blocked by the adjacent bipolar plates in the transverse direction of the flow channels alternately in only one direction, in each case normal to the plane.

4. The electrochemical system of claim 1, wherein the flow channels at an edge of the transition region adjacent to the distributing field are skewed relative to the orientation of the flow channels at an edge of the transition region adjacent to the active field.

5. The electrochemical system of claim 1, wherein the flow channels are aligned identically on an edge of the transition region adjacent to the distributing field and an edge of the transition region adjacent to the active field.

6. The electrochemical system of claim 5, wherein the flow channels on one side of the bipolar plate have a continuously straight shape, whereas the flow channels on the opposite side of the bipolar plate have a have a parallel offset.

7. The electrochemical system of claim 5, wherein the flow channels of adjacent bipolar plates diverge in a Y-shape within the transition region in a plan view of the bipolar plate.

8. The electrochemical system of claim 1, wherein the plurality of stacked bipolar plates form a fuel cell stack.

9. An electrochemical system, comprising:
a first bipolar plate; and
a second bipolar plate adjacent to the first bipolar plate in a stacked configuration, each of the first and second bipolar plates comprising:
a first half-plate that includes alternating peaks and valleys; and
a second half-plate that includes alternating peaks and valleys, wherein inner sides of the first half-plate and the second half-plate cooperate to form coolant channels between the first and second half-plates, the coolant channels being defined by the peaks of the first half-plate and the valleys of the second half-plate, and wherein an outer side of the second half-plate of the first bipolar plate faces an outer side of the first half-plate of the second bipolar plate, the outer side of the peaks of the second half-plate of the first bipolar plate delimits a first plurality of flow channels for operating media, and the outer side of the valleys of the first half-plate of the second bipolar plate delimit a second plurality of flow channels for operating media; and
a membrane assembly positioned between the first and second bipolar plates and extending between the first and second pluralities of flow channels, wherein in a transition region between an active field and a distributing field of each of the first and second bipolar plates, the arrangement of the first and second pluralities of flow channels relative to each other transitions from a first arrangement, wherein the outer side of the peaks of the second half-plate of the first bipolar plate are aligned with the outer side of the valleys of the first half-plate of the second bipolar plate, to a second arrangement, wherein the outer side of the peaks of the second half-plate of the first bipolar plate are offset from the outer side of the valleys of the first half-plate of the second bipolar plate.

10. The electrochemical system of claim 9, wherein in the first arrangement, the outer side of the peaks of the second half-plate of the first bipolar plate are aligned with the outer side of the valleys of the first half-plate of the second bipolar plate, such that the outer side of the peaks of the second half-plate of the first bipolar plate mirrors the outer side of the valleys of the first half-plate of the second bipolar plate.

11. The electrochemical system of claim 10, wherein in the second arrangement, the outer side of the peaks of the second half-plate of the first bipolar plate are aligned with the outer side of the peaks of the first half-plate of the second bipolar plate.

12. The electrochemical system of claim 9, wherein within the transition region, the peaks and valleys of the first half-plate of the first bipolar plate diverge with respect to the peaks and valleys of the second half-plate of the first bipolar plate in such a way that coolant channels of the first bipolar plate that are separate from and parallel to each other in the active field merge into a coherent coolant chamber extending over a plurality of peaks and a plurality of valleys.

13. The electrochemical system of claim 9, wherein the membrane assembly is flexible, such that the portion of the membrane assembly disposed between the portions of the first and second pluralities of flow channels that are in the second arrangement extends in a serpentine manner due to contact the outer side of the second half-plate of the first bipolar plate and the outer side of the first half-plate of the second bipolar plate.
